(19) United States
(12) Patent Application Publication
(10) Pub. No.: US 2013/0060533 A1
(43) Pub. Date: Mar. 7, 2013

(54) INFORMATION PROCESSING APPARATUS AND INFORMATION PROCESSING METHOD

(71) Applicant: Naoto Okutani, Kawasaki-shi (JP)

(72) Inventor: Naoto Okutani, Kawasaki-shi (JP)

(73) Assignee: CANON KABUSHIKI KAISHA, Tokyo (JP)

(21) Appl. No.: 13/592,065

(22) Filed: Aug. 22, 2012

(30) Foreign Application Priority Data
Sep. 6, 2011 (JP) 2011-193874

(51) Int. Cl. G06F 17/50

(52) U.S. Cl. 703/1

(57) ABSTRACT

An information processing apparatus for generating a thermal analysis model including a plurality of component models representing components includes an input unit configured to input component data representing the component models, an extraction unit configured to, based on the component data, extract a contact surface on which the plurality of components fastened with each other with a fastener component are in contact with each other, and an allocation unit configured to, based on the component data, allocate different thermal resistance values to a region pressed with the fastener component and a region other than the pressed region, of the extracted contact surface.

### BACKGROUND OF THE INVENTION

1. Field of the Invention

The present disclosure relates to a technique for generating a numerical analysis model from a CAD model to be analyzed.

2. Description of the Related Art

Computer aided design (CAD) is widely used to design components and products. A three-dimensional (3D) model (hereafter, referred to as a “CAD model”) generated by CAD is converted into a numerical analysis model (hereafter, referred to as an “analysis model”) to perform numerical value analysis simulation, and thus design content can be discussed based on an analysis result.

When thermal analysis is performed to convert the CAD model into the analysis model, much time is required to set generated at a contact portion between components. The thermal contact resistance refers to difficulty of a heat flow on a contact surface when the two components are in contact with each other. One of the reasons for causing the heat flow difficulty on the contact surface is that an area where the two components are actually in contact with each other is small due to small unevenness on surfaces of the components.

One of the reasons for requiring much time to set the thermal contact resistance is, when the number of components is increased, the number of contact portions between the components is also greatly increased accordingly. Further, since a set value varies depending on a contact state, a great amount of time is required to research an appropriate value for each contact portion.

To reduce works for setting the thermal contact resistance, a method is discussed for efficiently setting the thermal contact resistance. Japanese Patent Application Laid-Open No. 2007-316032 discusses a method for setting the thermal contact resistance according to a state of the contact portion between the components by a simple operation.

A contact pressure will be described herein as one of the parameters determining the thermal contact resistance. Since, when the contact pressure is high, the two components are in close contact with each other with the contact surface slightly deformed, and thus the thermal contact resistance becomes small. Thus, at the portion where the components are fastened with each other, as illustrated in FIG. 12, the value of the thermal contact resistance at a location near a fastened portion receiving a large contact pressure with a fastener component is different from the value at a location away from the fastener component receiving less contact pressure therewith. Therefore, at locations where the two components are in contact with each other, the value of the thermal contact resistance can be varied depending on the locations.

However, by conventional methods, since only one value of the thermal contact resistance is set for the contact surfaces fastened with a screw, an error between an actual phenomenon and the analysis model is large.

### SUMMARY OF THE INVENTION

The present disclosure is directed to an information processing apparatus capable of improving accuracy of a thermal analysis model and also efficiently generating the thermal analysis model.

According to an aspect disclosed herein, an information processing apparatus for generating a thermal analysis model including a plurality of component models representing components includes an input unit configured to input component data representing the component models, an extraction unit configured to, based on the component data, extract a contact surface on which the plurality of components fastened with each other with a fastener component are in contact with each other, and an allocation unit configured to, based on the component data, allocate different thermal resistance values to a region pressed with the fastener component and a region other than the pressed region, of the extracted contact surface.

Further features and aspects will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the disclosure and, together with the description, serve to explain the principles disclosed herein.

FIG. 1 is a block diagram illustrating a configuration of an information processing apparatus according to an exemplary embodiment.

FIG. 2 is a flowchart illustrating a flow of processing for setting thermal resistance according to the exemplary embodiment.

FIGS. 3A and 3B each illustrate a method for extracting a fastened portion.

FIG. 4 illustrates a contact surface of the fastened portion.

FIG. 5 illustrates an example of a database storing dimensional information about fastener components.

FIGS. 6A and 6B each illustrate a method for specifying a pressure region.

FIG. 7 illustrates an example of an adjustment screen for the pressure region.

FIGS. 8A and 8B each illustrate a method for specifying an enlarged pressure region.

FIGS. 9A and 9B each illustrate a divided contact surface.

FIG. 10 illustrates an example of a database storing thermal contact resistance information.

FIG. 11 illustrates an example of a list of thermal contact resistance allocated to surface IDs.

FIG. 12 illustrates contact pressure at the fastened portion.

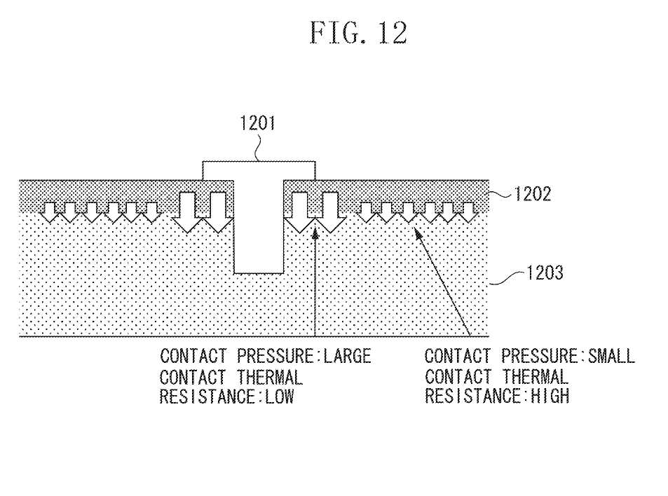

### DESCRIPTION OF THE EMBODIMENTS

Various exemplary embodiments, features, and aspects of the disclosure will be described in detail below with reference to the drawings.

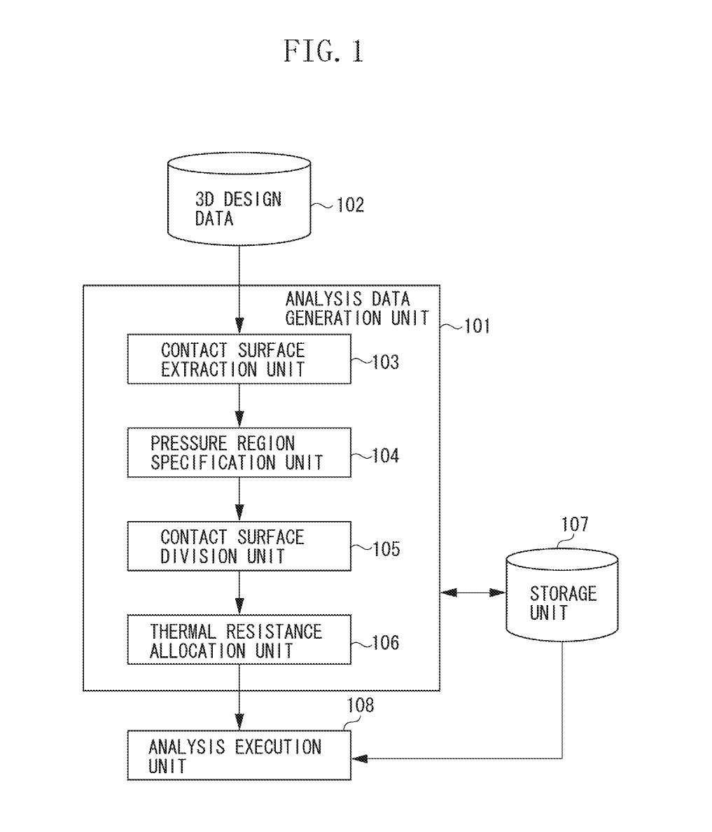

FIG. 1 is a block diagram illustrating a configuration of an information processing apparatus according to an exemplary embodiment of the present disclosure. The information processing apparatus is entirely controlled by a central processing unit (CPU) (not illustrated), and includes a read only memory (ROM) (not illustrated) and a random access memory (RAM) (not illustrated) where the CPU temporarily performs writing and reading when performing calculation processing.

An analysis data generation unit 101 inputs 3D design data 102 including a plurality of component models (hereafter, also referred to simply as “components”) representing components. The 3D design data 102 includes a configuration model, attribute information about a model, and geometric information thereabout as component data representing the component model. The data may be structured in any way, for example, component data may correspond to each of the plurality of components, or one piece of data may correspond to all of the plurality of components. Subsequently, the 3D design data 102 is referred to simply as the design data 102. The analysis data generation unit 101 appropriately inputs/outputs the data from/to a storage unit 107, and generates from the input design data 102 analysis data on which an analysis execution unit 108 performs thermal analysis processing. The analysis data generation unit 101 includes a contact surface extraction unit 103, a pressure region specification unit 104, a contact surface division unit 105, and a thermal resistance allocation unit 106.

The contact surface extraction unit 103 specifies a fastened portion where a plurality of (e.g., two) components are fastened with each other with a screw, which is a fastener component, based on the 3D design data 102, and then extracts a contact surface where two components are in contact with each other at the fastened portion.

The pressure region specification unit 104 inputs a dimension of a screw hole into a storage unit 107 to acquire dimensional information about a screw head portion output from the storage unit 107. The pressure region specification unit 104 specifies the region of the fastened portion defined based on the dimension as a region to be pressed (pressure region) with the screw.

The contact surface division unit 105 divides, using the pressure region, the contact surface into the pressure region and a non-pressure region that is not pressed based on the 3D design data 102.

The thermal resistance allocation unit 106 allocates different (contact) thermal resistance values to divided contact surfaces.

The storage unit 107 previously stores the dimensional information about the screws associated with each other depending on types of the screws. Further, the storage unit 107 previously stores information about combinations of materials of the components associated with information about thermal resistance allocated to each pressure state. Furthermore, the storage unit 107 stores, for example, a list of the thermal resistance values allocated to the contact surface. With this arrangement, the thermal resistance allocation unit 106 can automatically allocate the thermal resistance values.

The analysis execution unit 108 inputs analysis data generated by the analysis data generation unit 101 and the information about the thermal resistance corresponding to the analysis data that is stored in the storage unit 107 to perform thermal fluid analysis on a model for the thermal analysis (hereafter, referred to as a “thermal analysis model”). The storage unit 107 may be included in the analysis data generation unit 101.

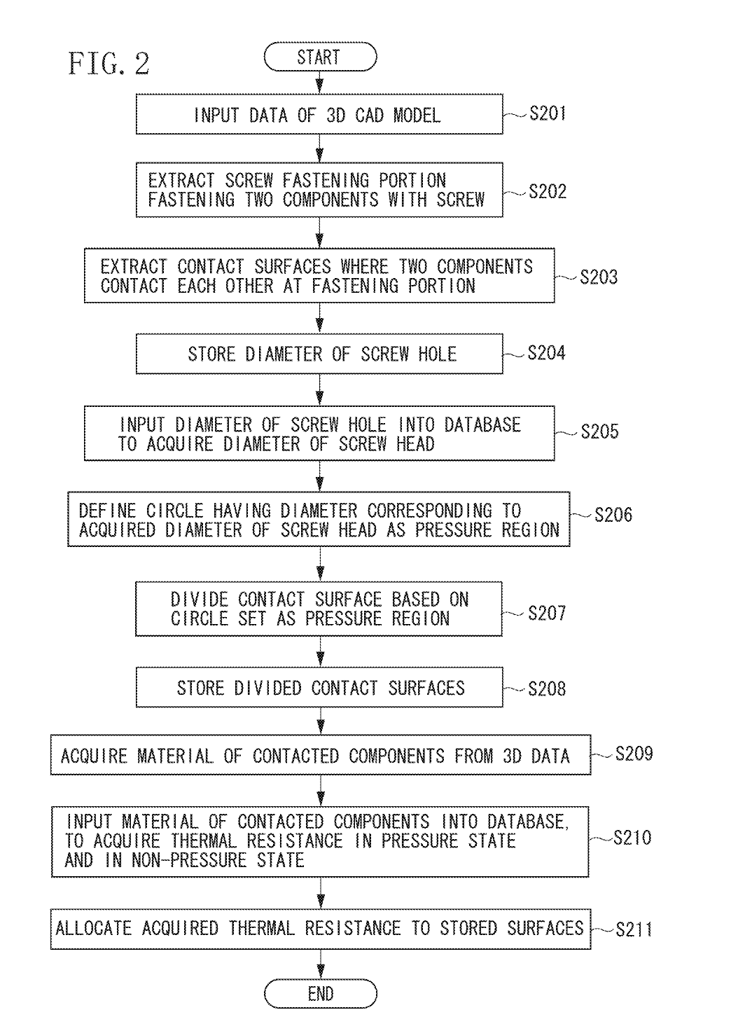

Hereafter, with reference to FIG. 2, a flow of processing performed by the information processing apparatus will be described. The CPU of the information processing apparatus performs each processing and control thereof.

In step S201, the analysis data generation unit 101 inputs the 3D design data 102 of the CAD model to be designed. The 3D design data 102 of the CAD model may be input from another computer system connected via a network, or from an external storage medium of the information processing apparatus.

The CAD model including the plurality of component models that can be acquired from the 3D design data 102 input in step S201 includes the fastened portion where two components are fastened with each other with the screw. In step S202, the contact surface extraction unit 103 extracts the fastened portion.

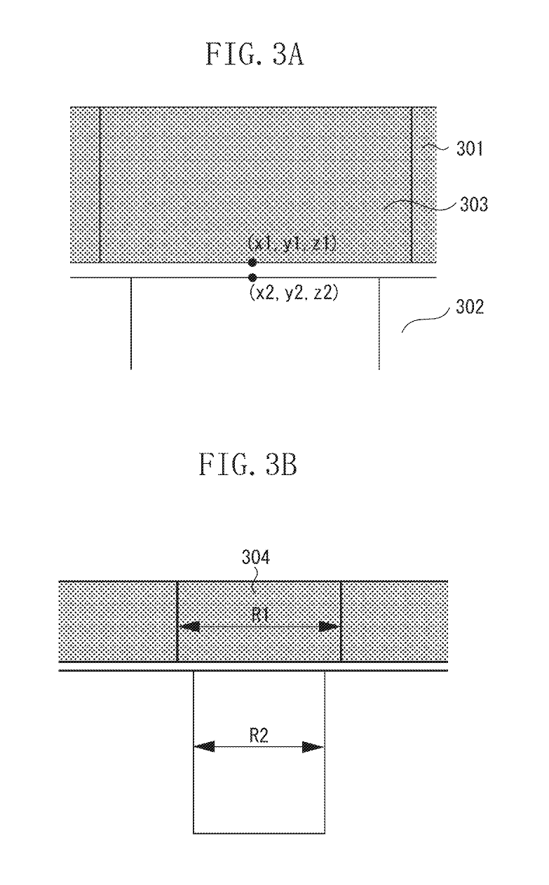

FIGS. 3A and 3B each illustrate an example of a method for extracting the fastened portion. The contact surface extraction unit 103 extracts a screw-fastened portion based on the geometric information about holes included in the component. More specifically, as illustrated in FIG. 3A, the contact surface extraction unit 103 extracts paired holes, whose minimum distance between center points of the paired holes is a predetermined threshold value or less. Further, as illustrated in FIG. 3B, the contact surface extraction unit 103 extracts as the screw-fastened portion a combination of the extracted holes, whose difference in a diameter is a threshold value or less. By performing such extraction, the contact surface extraction unit 103 can accurately discriminate the fastened portion from a mere hole. A method for extracting the fastened portion is not limited to the method described above, and a method may be included for extracting the screw-fastened portion based on positional information about the screw existing in the CAD model, or a method may be included in which a user specifies the fastened portion.

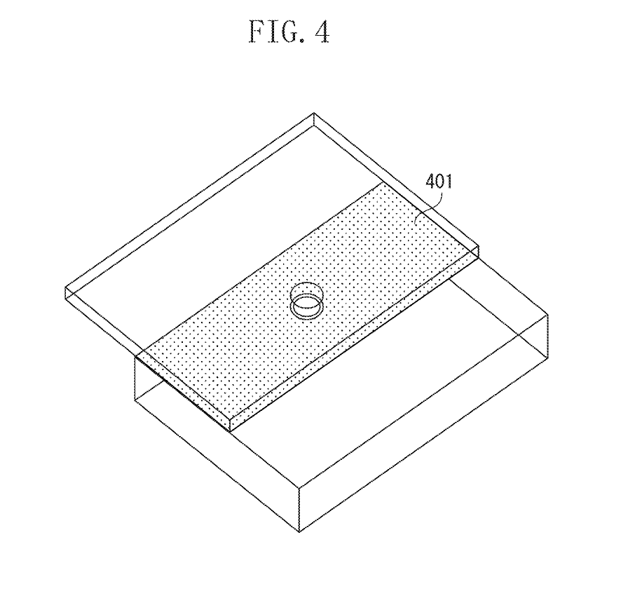

In step S203, the contact surface extraction unit 103 extracts the contact surface where two components are in contact with each other at the extracted fastened portion. FIG. 4 illustrates an example of a method for extracting the contact surface. The contact surface extraction unit 103 extracts an area 401 where surfaces including edges of the screw holes are in contact with each other as the contact surface.

In step S204, the pressure region specification unit 104 stores a diameter of the screw hole extracted in step S202.

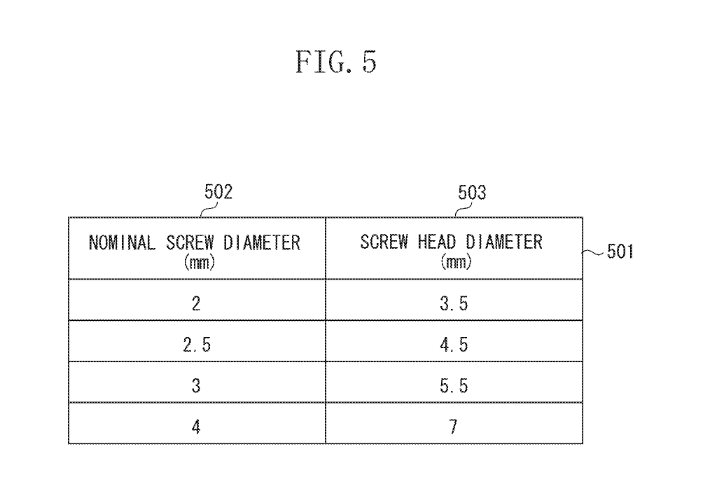

In step S205, the pressure region specification unit 104 inputs the diameter of the screw hole stored in step S204 into the database to acquire diameter information about a screw head. As illustrated in FIG. 5, the database previously stores in the storage unit 107 a typical nominal diameter 502 of the screw associated with a typical diameter 503 of the screw head. Upon input of the diameter of the screw hole, with reference to the nominal diameter of the screw, when the nominal diameter of the screw corresponding to the diameter of the screw hole can be detected, the database is used to define the nominal diameter as the nominal diameter of the screw. When the nominal diameter of the screw corresponding to the diameter of the screw hole cannot be detected, the database is used to define a closest value to the diameter of the screw hole as the nominal diameter of the screw. As described above, the pressure region specification unit 104 can acquire the diameter of the screw head corresponding to the set nominal diameter of the screw. The database herein stores typical dimensional information about the nominal diameter of the screw associated with information about the dimension of the screw head portion, and more specifically, the database may store the information about the nominal diameter further associated with the information about the diameter of the head portion depending on a type of a screw-head shape. In such a case, the pressure region specification unit 104 specifies the type of the screw-head shape based on the geometric information of the design data 102 to acquire the information about the diameter of the specified head portion. With this arrangement, the pressure region specification unit 104 can specify the pressure region more accurately. Further, for a case where a washer is disposed on the contact surface, the database may associate the typical dimensional information about the diameter of the screw head portion with the washer, and then the pressure region specification unit 104 may define an outer diameter of the washer corresponding to the nominal diameter of the screw as the pressure region. In this case, the user specifies the type of the screw and whether to dispose the washer for each fastened portion, or the pressure region specification unit 104 acquires the type of the screw and whether to dispose the washer from a component information holding unit that separately, previously holds component information.

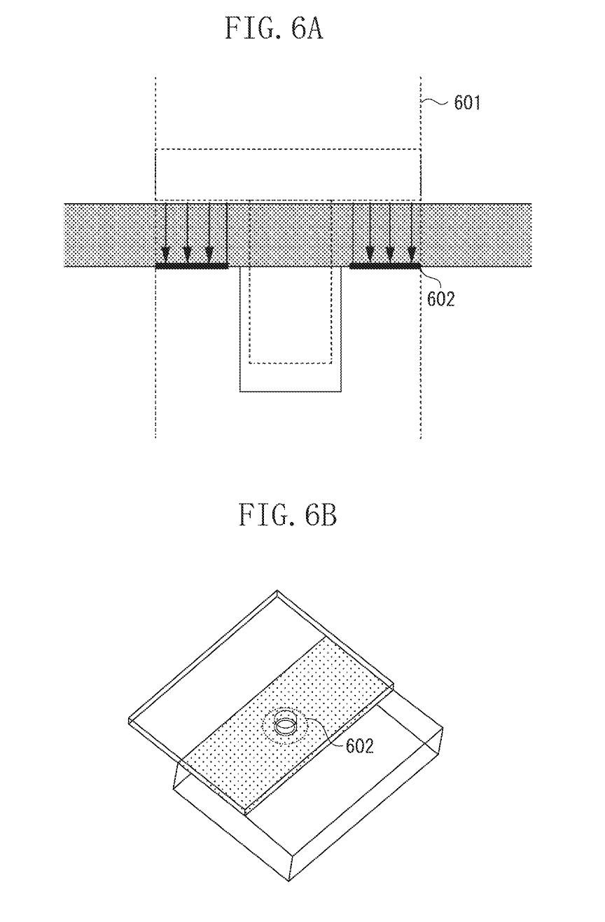

In step S206, as illustrated in FIGS. 6A and 6B, the pressure region specification unit 104 specifies the region where a circular cylinder 601 generated with the diameter acquired in step S205 and a region with which the contact surface extracted in step S203 intersects, and then set the region as a pressure region 602. A method for specifying the pressure region is not limited to the method described above. For example, to take it into account that the pressure region is expanded larger than an area of the screw head portion, the pressure region specification unit 104 may include a unit for adjusting the pressure region by multiplying the diameter of the screw head portion by an arbitrary coefficient.

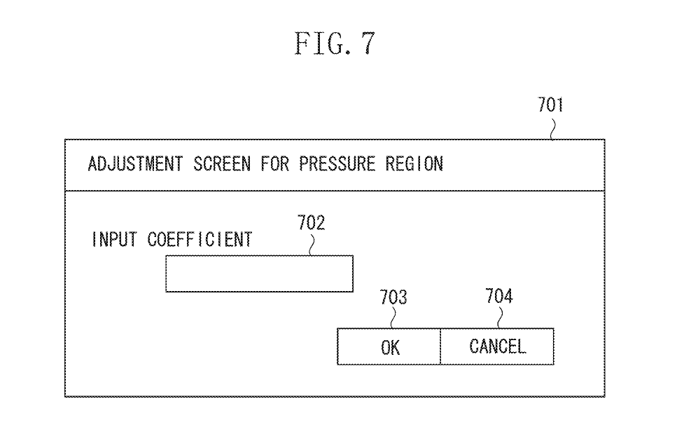

FIG. 7 illustrates an example of an adjustment screen for the pressure region. The user inputs an arbitrary value into a coefficient input field 702 via an adjustment screen 701 for the pressure region so that the pressure region specification unit 104 can set an adjustment coefficient for the pressure region. The diameter of the pressure region can be calculated by the following equations.

R=A×R_{b}
(R: diameter of pressure region, A: adjustment coefficient, and
Rb: diameter of screw head)

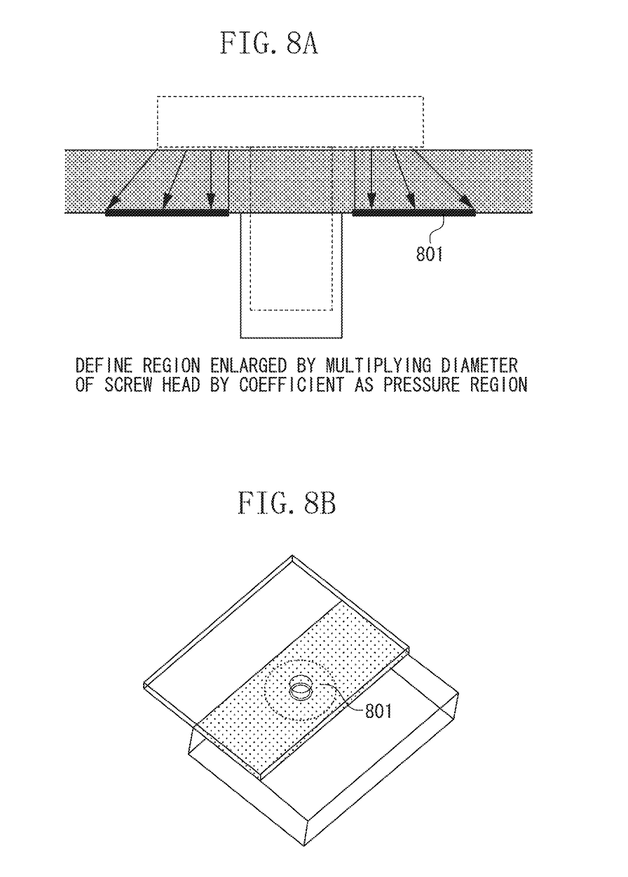

When the user selects an OK button 703, the set adjustment coefficient is determined. When the user selects a cancel button 704, the set adjustment coefficient is canceled. According to this example, as illustrated in FIGS. 8A and 8B, a circular area 801, which has the value of the diameter expanded by multiplying the diameter of the screw head by an arbitrary coefficient, is specified as a pressure region.

Since a method for expanding the pressure region varies intricately depending on a pressure state, which refers to a combination of elements including a type of a fastener component, and a thickness and materials of the components to be fastened. Thus, as an example in the present exemplary embodiment, a method will be described in which the user expands the pressure region with an arbitrary coefficient. The pressure region specification unit 104 may store as a parameter the type of the screw, the thickness and the materials of the components to be fastened, by previously acquiring tendency of expanding the pressure region based on experiments and analysis, to set the pressure region by automatically adopting the coefficient. When deterioration of accuracy is permissible, a predetermined size larger than the diameter of the screw hole may be set as the pressure region. In such a case, step S205 can be skipped.

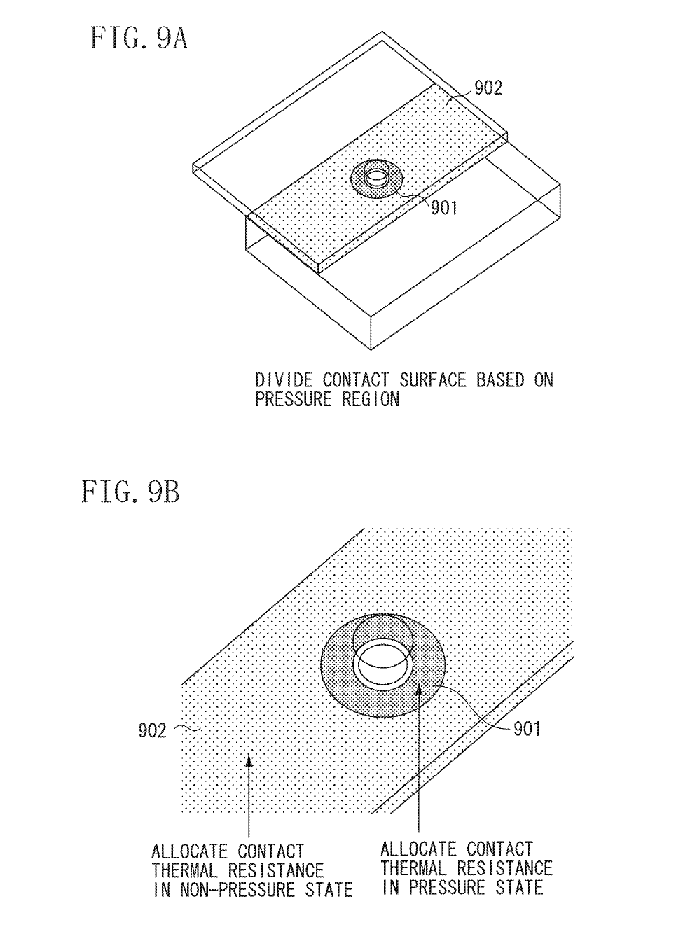

In step S207, the contact surface division unit 105 divides the contact surface based on the pressure region specified in step S206. FIGS. 9A and 9B illustrate the divided contact surfaces. The contact surface is divided into a main pressure surface 901 and a non-pressure surface 902 based on the circle set as the pressure region.

In step S208, the contact surface division unit 105 applies surface IDs indicating an identity (ID) of the surface to each of the main pressure surface 901 and the non-pressure surface 902, and then the storage unit 107 stores the main pressure surface 901 and the non-pressure surface 902 with their surface IDs. In step S209, the thermal resistance allocation unit 106 acquires from the 3D design data 102 material information about the components in contact with each other.

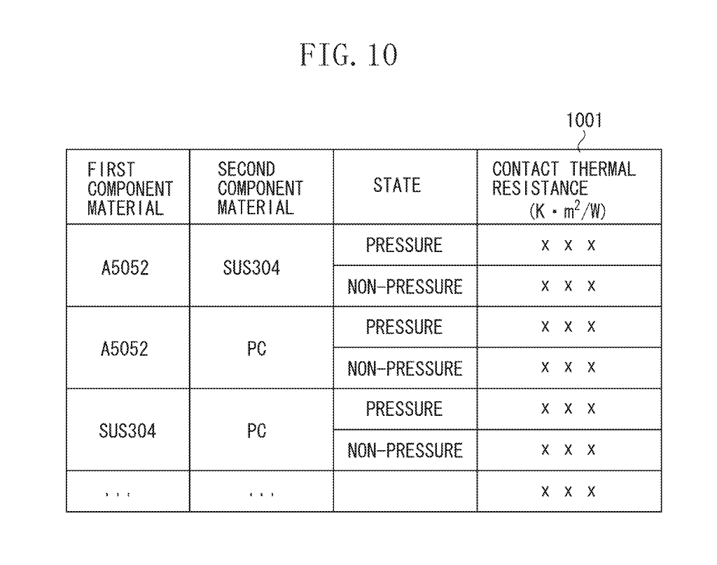

In step S210, the thermal resistance allocation unit 106 inputs the material information acquired in step S209 into the database in the storage unit 107 to acquire the thermal contact resistance in a pressure state and the thermal contact resistance in a non-pressure state that are associated with the combination of the input materials and are output from the storage unit 107. FIG. 10 illustrates an example of the database. As illustrated in FIG. 10, the database stores different kinds of thermal resistance information for each combination of materials acquired based on experiments and calculations. Further, the database stores the thermal resistance information associated the combination among each material with the values in the pressure state and the values in the non-pressure state. The user may input required information and perform calculation to acquire the thermal resistance value. Further, when the deterioration of the accuracy is permissible, the material does not have to be taken into account. In such a case, step S209 can be skipped.

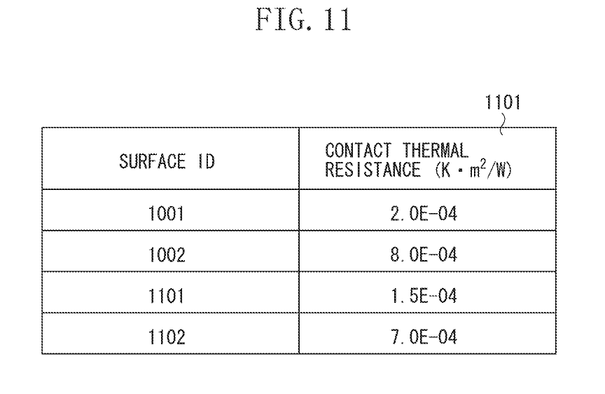

In step S211, the thermal resistance allocation unit 106 allocates the thermal resistance value acquired in step S210 to the surface IDs of the main pressure surface 901 and the non-pressure surface 902 stored in step S208, associates them with each other, lists the information, and then stores the listed information in the storage unit 107. FIG. 11 illustrates an example of a list of the thermal resistance information.

The thermal resistance allocation unit 106 completes the allocation of the thermal resistance by performing the above-described processing. The new CAD model to which the above-described thermal resistance is allocated is used as the thermal analysis model. In other words, the analysis execution unit 108 inputs the analysis model and the thermal resistance information list to perform the thermal analysis processing. The thermal analysis processing may include analysis, evaluation and optimization. The thermal analysis alone may be performed, the thermal analysis and the evaluation may be performed, or the thermal analysis, the evaluation, and the optimization may be performed.

According to the above-described exemplary embodiment, the screw is described as an example of the fastener component. However, a bolt, a nut, a clincher, or a pin can be also used.

The present disclosure can be realized by supplying to the system or the apparatus the storage medium storing program code of software that realizes a function of the above-described exemplary embodiment (e.g., the function illustrated in the above-described flowchart). In such a case, the function of the above-described exemplary embodiment can be realized when the system or the computer (or CPU or, micro processing unit (MPU)) of the apparatus reads the program code stored in a computer-readable storage medium to perform it.

According to the processing described above, the information processing apparatus can improve the accuracy of the thermal analysis model, and also efficiently generates the thermal analysis model. Further, since the information processing apparatus automatically allocates the thermal resistance values for which the contact pressure at the fastened portion is taken into account, time can be reduced for visually specifying the fastened portion and calculating the value of the thermal resistance when the thermal resistance is manually set, thereby efficiently generating the analysis model with high accuracy.

Aspects of the present disclosure can also be realized by a computer of a system or apparatus (or devices such as a CPU or MPU) that reads out and executes a program recorded on a memory device to perform the functions of the above-described embodiment (s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present disclosure has been described with reference to exemplary embodiments, it is to be understood that the disclosure is not limited to the disclosed exemplary embodiments. The scope of the following claims is to be accorded the broadest interpretation so as to encompass all modifications, equivalent structures, and functions.

This application claims priority from Japanese Patent Application No. 2011-193874 filed Sep. 6, 2011, which is hereby incorporated by reference herein in its entirety.

What is claimed is:

1. An information processing apparatus for generating a thermal analysis model including a plurality of component models representing components, the information processing apparatus comprising:
an input unit configured to input component data representing the component models;
an extraction unit configured to extract a contact surface based on the component data, on which the plurality of components fastened with each other with a fastener component are in contact with each other; and
an allocation unit configured to allocate different thermal resistance values based on the component data to a region pressed with the fastener component and a region other than the pressed region, of the extracted contact surface.

2. The information processing apparatus according to claim 1, further comprising:
a setting unit configured to set the pressed region based on the component data; and
a division unit configured to divide the contact surface based on the set region into the set region and a region other than the set region,
wherein the allocation unit is configured to allocate the different thermal resistance values to the respective divided regions.

3. The information processing apparatus according to claim 1, further comprising a setting unit configured to set the pressed region according to a type of the fastener component,
wherein the allocation unit is configured to allocate the different thermal resistance values to the set region of the contact surface and a region other than the set region thereof.

4. The information processing apparatus according to claim 1, further comprising an acquisition unit configured to acquire a thermal resistance value corresponding to a pressure state of the pressed region,
wherein the allocation unit configured to allocate the thermal resistance value based on the acquired thermal resistance value to the pressed region.

5. The information processing apparatus according to claim 4, wherein the pressure state includes a combination of a type of the fastener component, and thicknesses and materials of the components to be fastened.

6. The information processing apparatus according to claim 1, wherein the fastener component includes a screw.

7. The information processing apparatus according to claim 6, further comprising an acquisition unit configured to acquire a diameter of a head portion of the screw based on the component data,
wherein the pressed region is a circular area having a diameter corresponding to the diameter of the head portion of the screw.

8. The information processing apparatus according to claim 7, wherein the pressed region is an area obtained by multiplying a diameter of the circle by an arbitrary coefficient.

9. The information processing apparatus according to claim 7, wherein the allocation unit is configured to acquire the diameter of the head portion of the screw based on a correspondence relationship between a diameter of the screw and the diameter of the head portion of the screw.

10. A computer-readable storage medium storing a program for generating a thermal analysis model including a plurality of component models representing components, the program comprising:
inputting component data representing the component models;
extracting a contact surface based on the component data on which the plurality of components fastened with each other with a fastener component are in contact with each other; and
allocating different thermal resistance values based on the component data to a region pressed with the fastener component and a region other than the pressed region, of the extracted contact surface.

11. An information processing method for generating a thermal analysis model including a plurality of component models representing components, the method comprising:
inputting component data representing the component models;
extracting a contact surface based on the component data on which the plurality of components fastened with each other with a fastener component are in contact with each other; and
allocating different thermal resistance values based on the component data to a region pressed with the fastener component and a region other than the pressed region, of the extracted contact surface.
